(19) United States
(12) Patent Application Publication
(10) Pub. No.: US 2006/0232126 A1
(43) Pub. Date: Oct. 19, 2006

(54) Adaptive braking moment control method

(76) Inventors: Bernhard Giers, Frankfurt/Main (DE); Thomas Pröger, Rödermark (DE); Rainer Klusemann, Frankfurt/Main (DE)

Correspondence Address: Gerlinde Nattler;Continental Teves Inc, One Continental Drive, Auburn Hills, MI, 48326, US

(21) Appl. No.: 10/535,440

(22) PCT Filed: Dec. 2, 2003
(86) PCT No.: PCT/EP03/13528

§ 371 Date: Mar. 23, 2006

(30) Foreign Application Priority Data
Dec. 13, 2002 (DE) 10258647.0

(51) Int. Cl. B60T 8/34

(52) U.S. Cl. 303/113.1; 303/112

(57) ABSTRACT

In a method for actuating an electrically actuatable parking brake system, the brake torque on the braked wheels is reduced in order to prevent the wheels braked by the parking brake from locking when the vehicle is traveling at a vehicle speed exceeding a predetermined minimum speed and the wheel slip exceeds a defined threshold.

### BACKGROUND OF THE INVENTION

The present invention relates to a method for actuating an electrically controllable parking brake and an electrically controllable parking brake for motor vehicles comprising another electronic service brake system with anti-lock protection.

Up-to-date motor vehicle brake systems have to satisfy three functions mainly, i.e. service brake, parking brake and emergency brake functions, to meet legal provisions. To this end, prior-art brake systems generally include two brake systems independent of each other. Most frequently, the service brake is activated by application of a brake pedal and includes already in many cases electrohydraulic auxiliary means preventing the locking of the vehicle wheels, for example. Further, up-to-date motor vehicles are equipped with another, completely independent parking brake system which is actuated in many cases by means of a hand brake lever with a Bowden cable that acts mechanically on the brake actuators of the rear axle for brake application. In this arrangement, it is desired that the parking brake system be operable also during driving in order to enable the vehicle to come to a standstill even in the case of a defect of the service brake.

DE-A-195 16 639 discloses a service and parking brake system for motor vehicles, wherein independent actuating devices are provided to actuate the corresponding brake. The brake system comprises a pressure buildup means fed with external energy and allowing actuation of the friction brake of the parking brake system. Although the actuating device can be an element of a driving dynamics control device (ESP), no anti-lock function is provided for the parking brake system.

WO 99/38738 also discloses a motor vehicle brake system with a service brake and an electrically controllable parking brake, wherein the proportioning service brake system is equipped with ABS, TCS and ESP functions. The parking brake system is designed so that the service brake is driven upon actuation of the parking brake system at driving speeds of v≠0. The parking brake is applied only at driving speeds of v≈0. An anti-lock function for the parking brake is provided neither in this prior-art electronic parking brake.

DE-A-199 08 062 discloses a parking brake system for motor vehicles wherein the electronic parking brake is locked above a defined driving speed. Locking is necessary to prevent the motor vehicle from reaching an uncontrolled driving condition due to locking of the rear wheels when the actuators of the parking brake are enabled.

An object of the invention is to provide an electrically controllable parking brake system, which is safe to operate also at driving speeds of v≠0.

### SUMMARY OF THE INVENTION

This object is achieved by the method according to claim 1 and the parking brake according to claim 10.

The basic idea of the invention involves finding an operating point on the μ-slip curve during anti-lock control that is favorable for a great braking effect, while using a method as simple as possible.

It is the purpose of the method to avoid a too high brake torque in order to prevent the wheels from locking in a dynamic braking operation.

To calculate a new nominal value, it is preferred to assess the maximum wheel slip behavior in a preceding unstable phase (release phase).

As this occurs, the brake torque request (ForceRequest) is reduced in the subsequent braking phase in particular depending on the maximum wheel slip in the preceding unstable phase.

In the method of the invention, it is preferred that the wheel encountering the greatest wheel slip in the respective unstable phases is taken into account to determine the magnitude of the brake torque request similarly to the per se known ‘select-low’ principle in ABS service brakes.

It is expedient to monitor in these cases whether the wheel slip (SlipPH2max) exceeds a defined slip threshold (SlipThr) on a wheel. This fact allows favorably reducing the demand in application force for the next braking phase. The slip threshold SlipThr to be applied in this regard amounts to roughly 30% to 50% of 1 in particular.

A new nominal value (ForceRequest) is calculated especially according to the following formula:

$$ForceRequest ( n ) = ForceRequest ( n - 1 ) - ( ForceRequest ( n - 1 ) * SlipPH2 max * \frac{Factor 1}{Factor 2} )$$

In this formula, the factors Factor1 and Factor2 are proportionality constants allowing an individual adaptation of the control to the conditions in the vehicle (e.g. rating of the parking brake) in an expert manner. The ratio of Factor1/Factor2 is preferably lower than 1. In a particularly preferred fashion, the ratio is lower than roughly 0.4, e.g. roughly 0.33.

The index n indicates the value for the ForceRequest to be presently calculated. The index n−1 designates the value determined in a previous calculation.

According to a preferred embodiment, the new nominal value ForceRequest(n) for the next braking phase is calculated in such a fashion that the initialization value of the application force request ForceRequest(n−1) is the current value of the actual brake torque at the time of detection of wheel instability. The time of instability is determined in particular by monitoring the time when a predetermined slip threshold is exceeded. If a value for the actual brake torque is not available directly, that means, measured by sensors, it is suitable to calculate a corresponding value by way of a physical model that can be derived in an expert manner.

To avoid underbraking conditions, that is to say, too low brake pressures in a ratio relative to the current coefficient of friction, it is preferred according to the method of the invention to increase the brake torque with a lower brake torque gradient, especially in steps, after a defined period of time when the wheels remain close to the vehicle reference speed. It is suitable to choose this period of time in such a way that the delay times of the entire system, electromotive actor, inertias of the wheels, etc. are taken into account. This means the brake torque gradient should be as high as possible, however, not so high that the brake system is no longer able to appropriately react to the changed application force request.

The brake torque is measured preferably by means of the application force or by measuring the travel of a moved element at a mechanical application device.

The method of the invention is advantageous because locking of the wheels or overload of the application force in a parking brake actuated during driving can be avoided.

Further preferred embodiments can be seen and the following description of an embodiment by way of Figures.

### BRIEF DESCRIPTION OF THE DRAWINGS

In the drawings,

FIG. 1 shows a diagram for explaining the method of the invention with a simple anti-lock control.

FIG. 2 shows another diagram for explaining a method being extended according to the invention, with an anti-lock control taking into consideration previous brake torques.

### DETAILED DESCRIPTION OF THE DRAWINGS

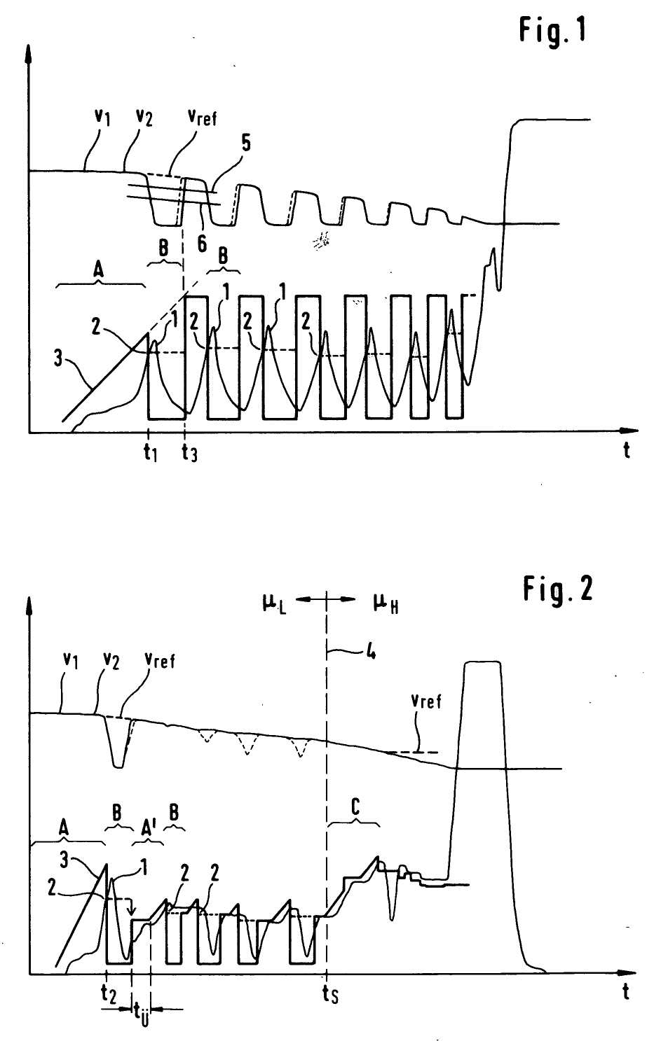

In the diagrams of FIGS. 1 and 2, the two curves v₁ and v₂ extending in the top range of the ordinate indicate the wheel speeds of the rear wheels being measured by means of conventional ABS wheel speed sensors. The curve 1 extending in the bottom part of the ordinate in FIGS. 1 and 2 indicates the present force at the actuators of the parking brake.

The dotted lines 2 in FIGS. 1 and 2 respectively indicate a stored value for the nominal value of the brake torque ForceRequest (n−1) in the current braking phase.

In range A in FIG. 1, initially the nominal value for the brake torque rises until a top slip threshold 5 SlipPH2max is exceeded by the wheel speeds (v₁, v₂). In Phase B (Release Phase) the nominal value for the brake torque is reduced so that the wheel speed will rise again after a certain reaction time of the entire system. The nominal value for the next braking phase is defined by using the brake torque that is currently determined at time t₁ (curve 1). When the slip falls under the bottom slip threshold 6 SlipPH1max (time t₃), the brake torque is re-increased by using the new nominal value ForceRequest (n).

In FIG. 2, the nominal value for the brake torque shown in range A will also rise at first until a slip threshold of 40% is exceeded by the wheel speeds (v₁, v₂). In this moment the nominal value ForceRequest (curve 2, time t₂) is significantly reduced and the current value of the current brake torque on curve 1 is stored in a memory. After rise of the wheel speeds, the brake torque will be re-increased, and the new nominal value is calculated from the brake torque of the preceding phase (ForceRequest (n−1) and a factor corresponding to the formula referred to hereinabove.

At time t_{S} (dotted line 4) an abrupt change in the coefficient of friction from a comparatively low coefficient of friction μ_{L} (e.g. on snow or ice) to a higher coefficient of friction μ_{H} (e.g. on dry roadways) is brought about to further explain the way the method is functioning. To avoid underbraking, the nominal value ForceRequest(n) is now gradually increased in range C until again a predetermined minimum slip occurs.

To avoid underbraking effects in a phase A′ where the brake torque is maintained constant, it can be monitored accordingly whether the wheel slip has not exceeded another predefined slip threshold for a defined time t_{Ü}. If this is the case, the nominal value is stepwise increased similar to the method described in the preceding paragraph.

1-11. (canceled)

12. A method for actuating an electrically controllable parking brake, wherein, at a driving speed exceeding a predetermined minimum speed, the brake torque at the braked wheels is reduced, in order to prevent locking of the wheels braked by the parking brake.

13. The method as claimed in claim 12,
wherein the wheel slip is monitored to determine the reduced brake torque.

14. The method as claimed in claim 13,
wherein the brake torque is reduced after detection of wheel slip above a predetermined threshold value on one of the wheels braked by the brake, and the brake torque is increased after detection of wheel slip below a predetermined threshold value.

15. The method as claimed in claim 14,
wherein the wheel slip of the wheels braked by the parking brake is monitored and an unstable phase is determined when at least one wheel speed is below the vehicle speed (v_{ref}) by a defined amount, and wherein in an unstable phase a new nominal value for the brake torque is calculated.

16. The method as claimed in claim 14,
wherein the wheel slip is monitored and an unstable phase is determined when at least the wheel slip of at least one exceeds a defined amount, and wherein in an unstable phase a new nominal value for the brake torque is calculated.

17. The method as claimed in claim 13,
wherein the wheel slip of the wheel braked by the parking brake is monitored, said wheel showing the instantaneously greatest wheel slip (Select Low).

18. The method as claimed in claim 13,
wherein the nominal value of the brake torque of the preceding calculation is also taken into consideration to calculate a new nominal value for the brake torque.

19. The method as claimed in claim 13,
wherein the actual brake torque (2) prevailing at the time when the slip threshold is exceeded or a quantity derived by way of an approximation model that corresponds largely to the present brake torque (2) is considered in order to calculate a new nominal value for the brake torque.

20. The method as claimed in claim 13,
wherein it is monitored over a defined period t_{Ü} that the wheel slip has not exceeded another predetermined slip threshold in order to avoid underbraking conditions.

21. The method as claimed in claim 12,
wherein the brake torque is increased in particular stepwise when underbraking occurs.

22. An electrically controllable parking brake for motor vehicles comprising another electronic service brake system with anti-lock protection,
wherein the parking brake includes an anti-lock device.

23. The brake as claimed in claim 22,
wherein the device is designed to reduce the brake torque at the braked wheels in order to prevent locking of the wheels braked by the parking brake.
